(19) United States
(12) Patent Application Publication
(10) Pub. No.: US 2024/0301572 A1
(43) Pub. Date: Sep. 12, 2024

(54) BIPOLAR ELECTRODE ASSEMBLY AND METHOD

(71) Applicant: MeliCon GmbH, Hueckelhoven (DE)

(72) Inventor: Ulrich MÜLLER, Hueckelhoven (DE)

(21) Appl. No.: 18/598,131

(22) Filed: Mar. 7, 2024

(30) Foreign Application Priority Data
Mar. 8, 2023 (EP) 231606468

(51) Int. Cl. C25B 11/032; C25B 11/036; C25B 11/042; H01M 4/86; H01M 4/88; H01M 8/10

(52) U.S. Cl. CPC C25B 11/032; C25B 11/036; C25B 11/042; H01M 4/861; H01M 4/8621; H01M 4/8631; H01M 4/88; H01M 2004/8694; H01M 2008/1095

(57) ABSTRACT

This disclosure relates to a bipolar plate electrode assembly of a fuel cell or of an electrolysis device comprising a stack of expanded metal layers arranged layerwise that form a gas diffusion electrode and a bipolar plate, wherein the stack is limited in the direction of the stack at least at one end by an outer expanded metal layer, wherein the outer expanded metal layer is areally materially bonded to the bipolar plate, characterized in that the outer expanded metal layer is made of two parts and comprises an expanded metal element as well as a metal insert inserted into the expanded metal element and materially bonded to the expanded metal element, wherein the outer expanded metal layer is materially bonded to the bipolar plate solely in the region of the metal insert.

### CROSS-REFERENCE TO RELATED APPLICATIONS

This application claims the benefit of European Application No. 231606468 filed on Mar. 8, 2023. The entire disclosure of the application referenced above is incorporated herein by reference.

### FIELD

This disclosure relates to a bipolar plate electrode assembly of a fuel cell or of an electrolysis device comprising a stack of expanded metal layers arranged layerwise that form a gas diffusion electrode and a bipolar plate, wherein the stack is limited in the direction of the stack at least at one end by an outer expanded metal layer, wherein the outer expanded metal layer is areally materially bonded to the bipolar plate. Moreover, the disclosure relates to a method for producing a bipolar electrode assembly of a fuel cell or of an electrolysis device.

### BACKGROUND

Fuel cells as well as electrolysis devices are known per se from the prior art. So, an electrolysis device is to be understood as a device that makes possible a material conversion, the so-called electrolysis, by means of electric current. According to the diversity of different electrolysis types, there is also a multitude of different electrolysis devices. For example, water can be split into hydrogen and oxygen by means of an electrolysis device for a hydrogen electrolysis.

Such an electrolysis device can be configured as a so-called PEM electrolysis device, wherein PEM (proton-exchange-membrane) describes a membrane that is permeable to protons. The proton-permeable membrane is usually placed between two electrodes, the anode and the cathode. Furthermore, a first bipolar plate is arranged at the anode and a second bipolar plate at the cathode, wherein the bipolar plates are designed to conduct reactant gas. The membrane, the electrode as well as the bipolar plates can collectively be referred to as an electrolysis cell. In case of the use of several electrolysis cells, the bipolar plate additionally electrically conductively connects the anode of an electrolysis cell to the cathode of the adjacent electrolysis cell.

For the above-described embodiment, distilled water is usually supplied to the anode side and split into hydrogen and oxygen at the proton-permeable membrane. The water oxidizes to oxygen at the anode. The protons pass through the proton-permeable membrane. Hydrogen is produced on the cathode side. To improve performance, several above-described electrolysis cells are usually arranged to an electrolysis cell stack or to a stack over each other or side by side. This being, the arrangement of the single electrolysis cells is generally achieved in a frame construction that presses together the single electrolysis cells to make possible a contact of the single electrolysis cells with one another.

Fuel cells are electrochemical energy converters and are used in mobile as well as in stationary applications. A chemical reaction energy of a continuously supplied fuel, for example hydrogen, and of an oxidizing agent, generally oxygen, is converted into electrical energy. To this end, fuel cells usually comprise an assembly that comprises, according to the above-described electrolysis device, a membrane arranged between two electrodes, the anode and the cathode, as well as a bipolar plate arranged on each of the electrodes. In case of the use of several fuel cells, the bipolar plate additionally electrically conductively connects the anode of a fuel cell to the cathode of the adjacent electrolysis cell.

The fuel is usually supplied by respectively one bipolar plate to the anode region and the oxidizing agent to the cathode region. The fuel is catalytically oxidized at the anode by releasing electrons. The remaining ions pass through the membrane and reach the cathode where they react with the oxidizing agent supplied to the cathode as well as the electrons led to the cathode to a reaction product, in the case of the above-described embodiment to water. Similarly to the above-described electrolysis cell arrangement that describes the arrangement of several electrolysis cells to an electrolysis cell stack, to improve performance several fuel cells are usually also arranged to a fuel cell stack or to a stack over each other or side by side. The arrangement of the single fuel cells is also generally achieved in a frame construction that presses together the single fuel cells to make possible a contact of the single fuel cells with one another.

The bipolar plate is of crucial importance for the efficiency and performance density of fuel cells and electrolysis devices. It serves among others to uniformly distribute the reaction gas, to dissipate or supply reaction heat as well as for the transfer of electric current inside the stack from cell to cell.

A gas diffusion layer that is provided for a fuel cell or an electrolyser is known from the prior art according to the US 2020/006782A1. This gas diffusion layer comprises three layers, wherein the first layer is provided to lie close to a proton-permeable membrane (PEM). The second layer is arranged between the first and the third layer and metallurgically bonded to these two layers, for example by means of welding. The third layer can consist of one or several expanded metal layers. A bipolar plate lies on the third layer over the whole surface. This being, the bipolar plate is metallurgically bonded to the third layer, in particular by means of welding. The US 2020/006782 A1 consequently constitutes a generic prior art.

A gas diffusion electrode for a fuel cell or an electrolysis device is known from EP 2 985 096 B1. The gas diffusion electrode has a multitude of expanded metal layers arranged layerwise, wherein adjacent expanded metal layers are connected areally with one another in contact points of their mutually facing flat sides by means of resistance pulse welding. The expanded metal layers that are more distant from the membrane preferably have larger mesh sizes in order to achieve a certain spring effect. The bipolar plate is applied onto the expanded metal layer that seals the gas diffusion electrode on the side away from the membrane. For the final production of a multi-cell stack, the cells are compressed with high pressures up to more than 50 bar. In the prior art, the bipolar plate is thus pressed onto the expanded metal layer of the electrode facing it.

Because of the spring properties of the cells compressed to stacks, setting phenomena do take place. If these setting phenomena exceed a certain limit, a close-fitting of the cells over the whole surface cannot be achieved any longer. Moreover, during proper operation oxide, formation occurs inside the respective cell, wherein the oxide formation is caused in particular due to the oxygen present at the anode side. The formation of an oxide layer inside a cell reduces a close-fitting of the electrode over the whole surface and of the bipolar plate with increasing operating time so that the contacting of the electrode and of the bipolar plate with one another reduces with increasing operating time and a proper operation of the fuel cell or of the electrolysis device is no longer achieved due to impaired electron transport.

It has been found that in particular the contact region between the bipolar plate and the gas diffusion electrode tends to comparatively strong oxide formation so that the ohmic resistance continues to increase. In order to keep the production rate at a constant level, higher currents are to be used with increasing ohmic resistance. The costs for a proper operation for example of an electrolyser mainly depend on the current consumption. The cost share is approximately 70%. If the ohmic resistance increases, this results in a higher current consumption or, for a constant current consumption, the conversion rate sinks. It is necessary to overcome this disadvantage.

Starting from the above-described prior art, the aim of this disclosure is to improve a fuel cell or an electrolysis device known from the prior art with respect to current consumption and service life.

### SUMMARY

For achieving this aim, the disclosure proposes a bipolar plate electrode assembly of a fuel cell or of an electrolysis device of the aforementioned type that is characterized in that the outer expanded metal layer is made of two parts and comprises an expanded metal element as well as a metal insert inserted into the expanded metal element and materially bonded to the expanded metal element, wherein the outer expanded metal layer is materially bonded to the bipolar plate solely in the region of the metal insert.

Due to the material bond of the bipolar plate and the gas diffusion electrode according to the disclosure, the disadvantages known from the prior art are completely remedied. On the one hand, a relative movement between the bipolar plate and the electrode is impeded so that negative setting phenomena are advantageously excluded. Furthermore, there cannot develop any oxide impairing the electron transport at the boundary layer between the bipolar plate and the electrode in the region of the bond material under normal use, this being due in particular to the fact that, due to the material bond that is configured in particular as a welding connection, an electroconductive material bridge is formed between the bipolar plate and the electrode that are not in active contact with the reaction gas. With the embodiment according to the disclosure, stationary positioning and charge transport can substantially be achieved unchanged, even after a long operating time. Thus, the embodiment according to the disclosure is maintenance-free at least in this respect.

According to the disclosure, the outer expanded metal layer is made of two parts, in particular of several parts. This being, the expanded metal layer is structured in a given number of expanded metal elements. However, these expanded metal elements are materially bonded with one another so that it results a continuous expanded metal layer. The configuration of an expanded metal layer made of several expanded metal elements has advantages with respect to the selected method of production since a simplification of the concrete method is thus made possible by applying specific advantageous welding methods. The outer expanded metal layer advantageously comprises two or more expanded metal elements among which one element is configured as a frame and the remaining elements as inserts, in particular as a metal insert, preferably as an insert made of expanded metal or of a wire mesh. This being, it is preferred that the outer expanded metal layer is materially bonded, in particular is welded to the bipolar plate solely in the region of the insert. The aim of the disclosure is thus achieved with an additional simplification of the method of production.

“Materially bonded” designates, in the sense of the disclosure, mainly a welding connection, in particular without additional material feed. However, the configuration as a solder connection is principally technically also possible. While welding connections are mechanically more stable, the configuration of solder connections involves less process-technical effort. As for the applied welding method, there do also exist gradations of the required effort for the method of production of the bipolar plate electrode assembly. Depending on the concrete process control described hereunder in more detail, fusion welding methods and resistance welding methods are preferred.

According to the disclosure, the electrode assembly comprises a stack of expanded metal layers arranged layerwise that form a gas diffusion electrode. This being, “expanded metal” means a metal sheet configured with openings in the surface, wherein the openings, also referred to as meshes, are created by offset cuts without loss of material with a simultaneously expanding distortion of the metal sheet. Several layers of expanded metal constitute the gas diffusion electrode according to the disclosure. Respectively adjacent expanded metal layers are preferably welded to one another. There thus results a sturdy stack made of a multitude of expanded metal layers, wherein four, five, six or more expanded metal layers can be provided depending on the later intended purpose.

The expanded metal layers connected with one another preferably by welding advantageously do constitute a smooth, planar and stable support for, on the one hand, a proton-conducting membrane of a membrane electrode assembly as well as, on the other hand, for a bipolar plate of the bipolar electrode assembly according to the disclosure. In the final assembled state, this bipolar plate is situated between two gas diffusion electrodes.

Adjacent expanded metal layers are areally connected with one another preferably in contact points of their facing flat sides by means of resistance welding. This being, due to the grid configuration of the expanded metal layers, “areally” within the sense of the disclosure does not mean over the whole surface. But, a connection in the sense of an areal configuration takes place in the contact points of two adjacent expanded metal layers that regularly extend over the whole facing flat sides of the expanded metal layers as a result of the grid configuration of the expanded metal layers. Insofar not only a point-shaped connection is achieved, but rather a connection that is insofar areal as a multitude of contact points are formed in a regular arrangement over the whole surface of the flat side mutually in contact of adjacent expanded metal layers. Thus, a very sturdy assembly of expanded metal layers is advantageously provided.

For manufacturing reasons, the single expanded metal layers have a plastic height that is greater than the sheet thickness of the metal panels selected as basic material. This plastic height gives specific spring properties to the expanded metal that are advantageously preserved when connecting the expanded metal layers by means of resistance welding. The expanded metal layers welded with one another to a stack in the final assembled state thus have specified spring properties that can be calculated on the basis of the spring characteristics of the single expanded metal layers and that are reproducible. Due to the constructive design according to the disclosure, it is thus advantageously possible to influence the later contact force between the gas diffusion electrode on the one hand and the fitting membrane thereon on the other hand in order to ensure a permanently secure fitting of the membrane at the or at the associated gas diffusion electrodes.

A “bipolar plate” in the sense of the disclosure designates a plate made of a metallic material, such as preferably titanium, with specific dimensions. Due to its advantageous resistance to corrosion, to its advantageous mechanical stability and electrical conductivity combined at the same time to its light weight, titanium is particularly preferred. According to the disclosure, the term “plate” designates a component laid out in the plane that is made of a metal resistant to bending and that is loaded by forces acting perpendicularly thereon and by moments about axes that lie in the plate plane. Depending on its other geometrical structure, it always has two oppositely formed large surfaces that extend two-dimensionally along the plate plane. The plate is configured in particular cuboid. This being, it has two oppositely formed large surfaces and four small surfaces that circumferentially connect the two large surfaces.

When the bipolar plate electrode device is in the final assembled state, the outer expanded metal layer is always a part of the gas diffusion electrode. Thus, in this case, the gas diffusion electrode is constituted by the whole stack. However, the manufacturing technology has to be differentiated. So it might be that first the electrode is end manufactured and that then the bipolar plate is connected to the electrode. On the other hand, it is also possible to first connect the bipolar plate to the later outer expanded metal layer and then to connect the compound of the bipolar plate and the expanded metal layer to a premanufactured stack of expanded metal layers that constitute the gas diffusion electrode. In this case, the stack that previously already constituted a gas diffusion electrode is completed by a further expanded metal layer. The later completed and henceforth outer expanded metal layer in the finished bipolar electrode assembly is equally part of the gas diffusion electrode.

Moreover, it is preferred to make at least the outer expanded metal layer, preferably however all the expanded metal layers of the stack, of titanium. Because of its advantageous resistance to corrosion, its advantageous mechanical stability and its electrical conductivity combined at the same time to its light weight, titanium is particularly favorable not only for the bipolar plate, but also for the expanded metal layers. Furthermore, titanium in its configuration as expanded metal layer has advantageous spring elastic properties in direction of the surface normal for the later fuel cell or electrolysis device.

At least the outer expanded metal layer preferably has a grid structure, wherein the grid structure consists of intersecting webs that form single meshes on the one hand and intersection points on the other hand, wherein the flat outer side is formed by a multitude of intersection points arranged in a common plane, wherein materially bonded connection points are formed between each intersection point and one corresponding contact point of the bipolar plate. An “areal” connection as previously described with respect to the connection of single expanded metal layers is to be understood here as well.

According to a preferred characteristic of the disclosure, it is provided that at least one part of the expanded metal layers of the stack has different mesh sizes from one another. A specific mesh size is provided depending on the expanded metal layer. This mesh size can vary from expanded metal layer to expanded metal layer. This configuration is advantageous in two respects. This supports a turbulent fluid throughflow that is desirably to be achieved in the intended use case. Moreover, it results in an uneven distribution of the contact points developing between the single expanded metal layers, which additionally enhances the form stability of the later compound.

According to a further characteristic of the disclosure, it is provided that the meshes of the outer expanded metal layer adjacent to the bipolar plate of the bipolar electrode assembly have the largest mesh size. This being, the expanded metal layers are preferably successively arranged in the stack so that the mesh size of the expanded metal layers reduces in the direction of the stack starting from the outer expanded metal layer connected to the bipolar plate. This being, the aim of the larger mesh expanded metal is on the one hand to form a stable and plane surface but on the other hand also to build up a spring effect. It is consequently preferably provided that the outer expanded metal layer that, in the intended use case, comes into contact with the bipolar plate of the bipolar plate electrode assembly has the largest mesh size of all expanded metal layers. So, it is ensured that the outer expanded metal layer connected to the bipolar plate has particularly enhanced spring-elastic properties. This is favorable for the method of manufacturing as well as for the later fuel cell or the electrolysis device. The outer expanded metal layer preferably has a regular mesh size. The preferred mesh size of the outer expanded metal layer consists in particular of a mesh width of 10 to 15 mm, in particular of 12 mm, and of a mesh length of 4 to 8 mm, in particular of 6 mm.

Moreover, the disclosure relates to a method for producing a bipolar plate electrode assembly according to the disclosure of a fuel cell or of an electrolysis device according to the disclosure for which
a stack of expanded metal layers arranged layerwise, a bipolar plate and an additional expanded metal layer are provided;
a planar section comprising several meshes is completely removed from the additional expanded metal layer, wherein at least one first expanded metal element in the form of the removed section and a second expanded metal element in the form of the remaining expanded metal layer with a through hole corresponding to the removed section are formed out of the additional expanded metal layer;
the second expanded metal element is welded onto an outer expand metal layer of the stack by means of resistance welding,
the first expanded metal element is then inserted again into the through hole of the second expanded metal element,
the bipolar plate is welded onto the planar side of the first expand metal element facing away from the stack by means of resistance projection welding, wherein the bipolar plate and the first expanded metal element are welded to one another preferably in a single operation and wherein the first expanded metal element and the second expanded metal element are welded to one another.

The method according to the disclosure serves for producing the bipolar plate electrode assembly according to the disclosure. The process-related advantage consists in that all the components of the assembly can be materially bonded to each other by means of resistance welding. Resistance welding methods are comparatively easy as for control technology and in particular require less sophisticated welding tools compared to other welding methods. Because of the nature of the bipolar plate, a direct welding to the electrode by means of resistance welding is not possible. Nevertheless, due to the method according to the disclosure, this can be made possible due to innovative and synergetic intermediate steps integrated into the method. The process control is based on the recognition that expanded metal layers, in particular with a larger mesh size, are expanded during welding in the surface direction. The plastic height of a welded expanded metal layer is thus lower than the plastic height of an identical unwelded expanded metal layer. If single elements (first expanded metal element) are first removed from an unwelded expanded metal layer (additional expanded metal layer) and then inserted again into the remaining expanded metal layer (second expanded metal element) now welded with an expanded metal layer of the stack, the welded second expanded metal element has a lower plastic height than the previously removed first expanded metal element. When the first expanded metal element is inserted as intended into the second expanded metal element, the first expanded metal element thus projects over the second expanded metal element in the thickness direction of the stack or direction of the stack. The special feature of the disclosure consists in that the projecting part of the first expanded metal element can be used as a weld projection in a resistance projection welding method when welding the bipolar plate and the outer expanded metal layer. This being, the weld projection in the form of the projecting part is almost entirely melted off. There thus exists a materially bonded connection between the bipolar plate and the outer expanded metal layer in the region of the first expanded metal element. In the region of the second expanded metal element, a bonding to the bipolar plate by means of compression known from the prior art can be realized in the later course. It is furthermore provided that the single expanded metal elements are welded to one another during this welding step to a largely uniform outer expanded metal layer. In the end, the previously separated elements are thus reassembled to an expanded metal layer.

By contrast, a material bond does exist in the region of the second expanded metal element between the outer expanded metal layer and the adjacent expanded metal layer of the gas diffusion electrode. There consequently exists a materially bonded conductivity link between the bipolar plate and the gas diffusion electrode over the first expanded metal element to the second expanded metal element towards the expanded metal layer adjacent in the stack.

For forming the first expanded metal element, it is preferably provided that the section is removed from the additional expanded metal layer by means of a cutting process, in particular of laser cutting. Laser cutting can be technologically automated with outstanding quality and is highly accurate.

It is preferably provided that the second expanded metal element is welded onto the expanded metal layer of the gas diffusion electrode or of the stack of expanded metal layers that has the largest mesh size inside the gas diffusion electrode or the stack of expanded metal layers, wherein the second expanded metal element has a larger mesh size than the expanded metal layer of the gas diffusion electrode onto it. It is so ensured that the outer expanded metal layer connected to the bipolar plate has particularly great spring-elastic properties.

According to a preferred characteristic of the disclosure, it is provided that the first expanded metal element is inserted into the second expanded metal element in such a manner that its relative orientation to the second expanded metal element corresponds to the orientation before its removal. In particular, the mechanical properties such as in particular the spring resiliency and stability, of the resulting expanded metal layer are retrieved almost without loss by using the original connection points. However, it is also principally conceivable to set an orientation of the first expanded metal element deviating from the original orientation. Meshes twisted against each other in sections can thus be formed inside an expanded metal layer. In particular, the forming of a laminar flow of the fluid passing through the electrode assembly is thus advantageously avoided.

A preferred further development of the method according to the disclosure provides that not only a single section is removed from the additionally provided expanded metal layer but a multitude of such sections of the same type. Particularly preferably a total of four sections are removed from the expanded metal layer in order to be later inserted again into the second expanded metal element provided with a corresponding number of through holes after the welding thereof. The sections are preferably selected in such a manner that through holes arranged regularly distributed over the second expanded metal element are formed. Several weld projections are thus provided for the later resistance projection welding. The connecting surface between the bipolar plate and the outer expanded metal layer is thus increased and the stability during the welding operation is improved by correspondingly regularly distributed bearing surfaces in the form of projections. It is concretely provided that in accordance with the first section further sections are completely removed from the additional expanded metal layer and/or from the second expanded metal element for forming further expanded metal elements before welding the second expanded metal element. They will preferably be inserted again into the welded second expanded metal element and subsequently welded preferably simultaneously to the first expanded metal element, to the bipolar plate on the one hand and to the second expanded metal element on the other hand by means of resistance projection welding.

The disclosure also comprises a modified method for producing a bipolar plate electrode assembly according to the disclosure of a fuel cell or of an electrolysis device according to the disclosure for which
a stack of expanded metal layers arranged layerwise, a bipolar plate and an additional expanded metal layer are provided;
a planar section comprising several meshes is completely removed from the additional expanded metal layer, wherein at least one first expanded metal element in the form of the removed section and a second expanded metal element in the form of the remaining expanded metal layer with a through hole corresponding to the removed section are formed out of the additional expanded metal layer;
the first expanded metal element is welded onto an outer expanded metal layer of the stack by means of resistance welding,
the second expanded metal element is then set onto the outer expanded metal layer, wherein the first expanded metal element is positioned in the through hole of the second expanded metal element,
the bipolar plate is welded onto the planar side of the second expand metal element facing away from the stack by means of resistance projection welding, wherein the bipolar plate and the second expand metal element are welded to one another preferably in a single operation and wherein the second expanded metal element and the first expanded metal element are welded to one another.

All the advantages of the first method according to the disclosure can also be achieved with this second method according to the disclosure. The second method differs from the first method only in the order in which the first and the second expanded metal element are inserted. The second method can also be advantageously further developed by the preferred characteristics of the first method. A common inventive idea thus links both methods.

The disclosure also comprises an alternative method for producing the bipolar plate electrode assembly according to the disclosure of a fuel cell or of an electrolysis device according to the disclosure for which
a stack of expanded metal layers arranged layerwise, a bipolar plate and an additional expanded metal layer with a multitude of intersection points arranged regularly distributed over a flat side are provided;
the bipolar plate is provided with a multitude of through holes, wherein the through holes entirely penetrate through the bipolar plate and extend between the two large surfaces;
the bipolar plate and the additional expanded metal layer are brought into contact with one another, wherein each through hole of the bipolar plate is positioned over an intersection point of the expanded metal layer;
the bipolar plate and the additional expanded metal layer are aerally welded to one another to a compound by means of a fusion welding method, wherein at least one welding electrode is inserted into the through holes and a welding connection is formed between the bipolar plate and the expanded metal layer in the region of the intersection points;
the expanded metal layer of the stack that is on the compound side and the additional expanded metal layer of the compound are areally welded to one another by means of resistance welding.

Due to the alternative process control according to the disclosure, a material bond is achieved between the gas diffusion electrode and the bipolar plate with the particular advantage that setting phenomena and the formation of oxides at the boundary layer between the electrode and the bipolar plate are avoided. The method has technically the advantage that the additional expanded metal layer does not have to be split up into single elements. Thus, this part of the method is advantageously simplified. In contrast to the first method according to the disclosure, due to the lack of a weld projection, the welding of the additional expanded metal layer and the bipolar plate cannot be realized by comparatively easy resistance projection welding but has to be realized by a fusion welding method. To this end, in particular the bipolar plate is provided before welding with through holes in order to create a welding-related access for the welding electrode to the expanded metal layer.

Basically, a multitude of fusion welding methods are appropriate for the use in the alternative method according to the disclosure. However, the inert gas fusion welding, in particular Tungsten Inert G # as welding (TIG welding) has proved to be advantageous. TIG welding takes place under inert gas atmosphere with argon.

According to the method, the bipolar plate is provided with holes. These holes are preferably made in the bipolar plate preferably made of titanium by laser cutting. The holes correspond with respect to their geometrical size and orientation to the intersection points of the meshes of the expanded metal layer adjacent to the bipolar plate. In the course of the TIG welding process, the holes are filled with an additive, in particular titanium. This being, there results a material bond between on the one hand the expanded metal layer, formed in particular of titanium, and the bipolar plate formed in particular of titanium, by introducing titanium as an additive. In this way, a metal-to-metal connection (without titanium oxide) is created between the expanded metal layer and the bipolar plate. It results that the bipolar plate is permanently materially bonded to the expanded metal layer so that setting phenomena are avoided. Additionally, a metal-to-metal connection is created between the expanded metal layer and the bipolar plate so that a minimized ohmic resistance develops. As a result, the ohmic resistance between the gas diffusion electrode and the bipolar plate is reduced, and this also permanently.

Moreover, the disclosure relates to the use of a bipolar plate electrode assembly on the anode side, consequently a bipolar plate anode assembly.

An expanded metal layer of stainless steel is preferably fixed on the cathode side of the bipolar plate. The connection to the bipolar plate also takes place by welding, namely by resistance welding or even by beam welding, in particular of laser beam welding. But soldering, in particular laser soldering, is also conceivable.

With respect to the disclosure, in particular the expanded metal layer of the stack forming the gas diffusion electrode that terminates the stack on the bipolar plate side is of crucial importance, this in particular because it technically forms the connecting link between the electrode and the bipolar plate. In the sense of the disclosure, this expanded metal layer is designated as the “outer” expanded metal layer.

However, the outer expanded metal layer arranged at the other end that terminates the stack that forms the electrode on the membrane side is also of crucial importance for this disclosure, this since the disadvantageous formation of oxides also concerns the connection between the membrane and the expanded metal layer on the membrane side. Thus, the disclosure also comprises a system that has a membrane and the bipolar plate electrode assembly according to the disclosure. In this respect, it is preferably provided that at least the surface of the other outer expanded metal layer on the membrane side is provided with an electrically conductive coating. The coating can cause in particular a catalysis of the chemical reaction terminating at the electrode as intended, provide corrosion protection for the material of the expanded metal layers and/or improve the electroconductivity of the expanded metal layer. In this way, the efficiency and resistance of the electrode according to the disclosure can be improved. According to a preferred characteristic of the disclosure, it is provided that the coating is formed of gold, silver, palladium, platin, rhodium, iridium, rhenium, ruthenium, molybdenum, tungsten, nickel or a compound with at least one of these metals. All the aforesaid metals have particularly advantages in at least one of the aforesaid fields, catalysis, anti-corrosion protection or electrical conductivity. Particularly preferably, the coating is made of iridium and/or of an iridium containing compound, in particular iridium oxide. It has been found that iridium and the compounds thereof, in particular iridium oxide, are particularly favorable with respect to the reactions developing during an electrolysis in an electrolysis device, in particular the water electrolysis and that it provides catalytic, anticorrosive and conductivity-related improvements.

Nonetheless, the matter is for iridium of a comparatively rare element, the extraction quantity of which is limited for an indefinite period of time. It is thus preferred that solely the outer expanded metal layer on the membrane side, in particular solely the surface of the outer expanded metal layer on the membrane side that is facing away from the stack, is coated with iridium and/or with an iridium containing compound, in particular with iridium oxide. Referring to the stack of expanded metal layers according to the disclosure, it has been found that a coating of the expanded metal layer adjacent for the intended use to the membrane or that the surface thereof on the membrane side with iridium or with an iridium containing compound is sufficient to achieve the related advantages.

According to a preferred characteristic of the disclosure, it is provided that the stack comprises at least sectionwise uncoated expanded metal layers, wherein coated and at least sectionwise uncoated expanded metal layers are welded to one another and compressed to form the compound. The expanded metal layers preferably bonded to one another by welding do advantageously form a smooth, plane and stable support for the proton-conducting membrane. In the final assembled state of the fuel cell or of the electrolysis device, this membrane is situated between two gas diffusion electrodes, wherein the one of the two gas diffusion electrodes is formed, in the case for example of the water electrolysis, of titanium (oxygen side) and the other gas diffusion electrode of stainless steel (hydrogen side).

According to a further characteristic of the disclosure, it is provided that the outer expanded metal layer on the bipolar plate side is configured uncoated.

Further characteristics and advantages of the disclosure result from the following describing with reference to the accompanying drawings. This being, FIG. 1 to FIG. 5 relate to a first method according to the disclosure and FIG. 1, FIG. 6 and FIG. 7 relate to a second alternative method according to the disclosure.

### BRIEF DESCRIPTION OF THE DRAWINGS

In particular, FIG. 1 shows a schematic representation of a top view and a side view of an expanded metal layer according to the disclosure for being used in the methods according to the disclosure.

FIG. 2 shows a schematic enlarged representation of a top view of a first expanded metal element and a schematic representation of a top view of a second expanded metal element according to a first method control according to the disclosure.

FIG. 3 shows a schematic cut side view of a representation of an intermediate product of the first method control according to the disclosure.

FIG. 4 shows a schematic cut side view of a representation of an intermediate product of the first method control according to the disclosure.

FIG. 5 shows a schematic cut side view of a representation of the bipolar plate electrode assembly according to the disclosure according to the first method control according to the disclosure.

FIG. 6 shows a schematic representation of a top view and of a side view of a bipolar plate according to the disclosure provided with through holes according to a second method control according to the disclosure.

FIG. 7 shows a schematic top view and of a side view of an intermediate product of the second method control according to the disclosure.

### DETAILED DESCRIPTION

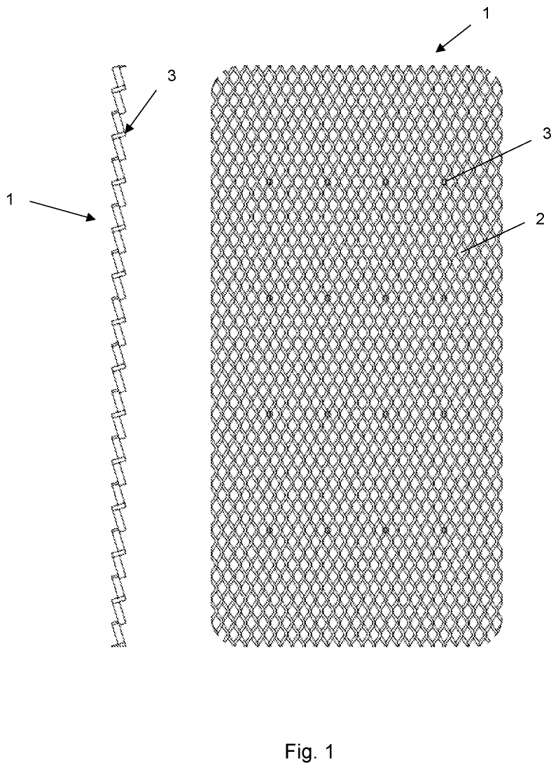

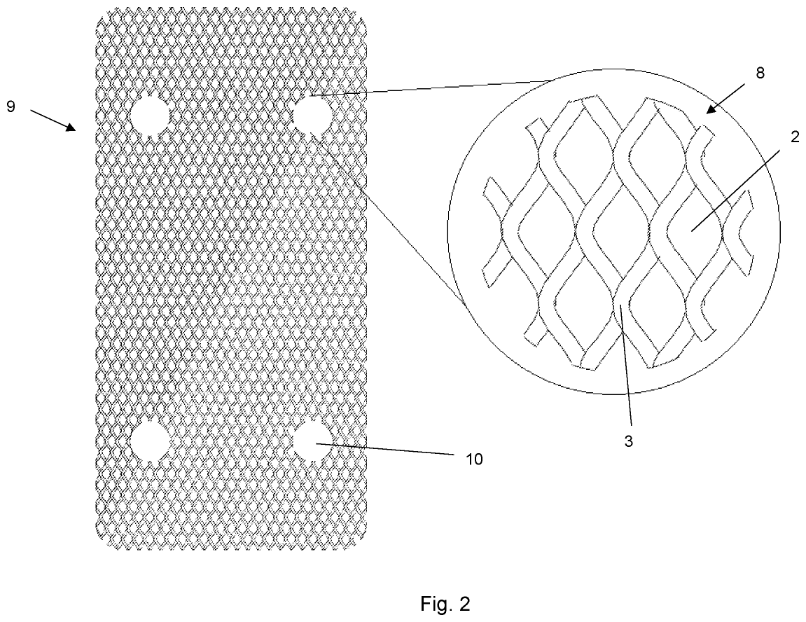

Here, the expanded metal layer 1 is made of titanium. It comprises a grid structure that consists of intersecting webs that form single meshes 2 on the one hand and intersection points 3 on the other hand. The planar outer side or flat side of the expanded metal layer 1 is formed by a multitude of intersection points 3 arranged in a common plane. In the top view of FIG. 2, a total of 16 intersection points are marked as an example with one point each.

In the present case, the expanded metal layer 1 has one regular mesh size that is uniform for all the meshes. The mesh size of the expanded metal layer is formed in particular of a mesh width of 12 mm and a mesh length of 6 mm. Referring to the drawing plane, the mesh length between two directly adjacent intersection points 3 of a mesh 2 is measured in the horizontal direction while the mesh width between two indirectly adjacent intersection points 3 of a mesh 2 is measured in the vertical direction.

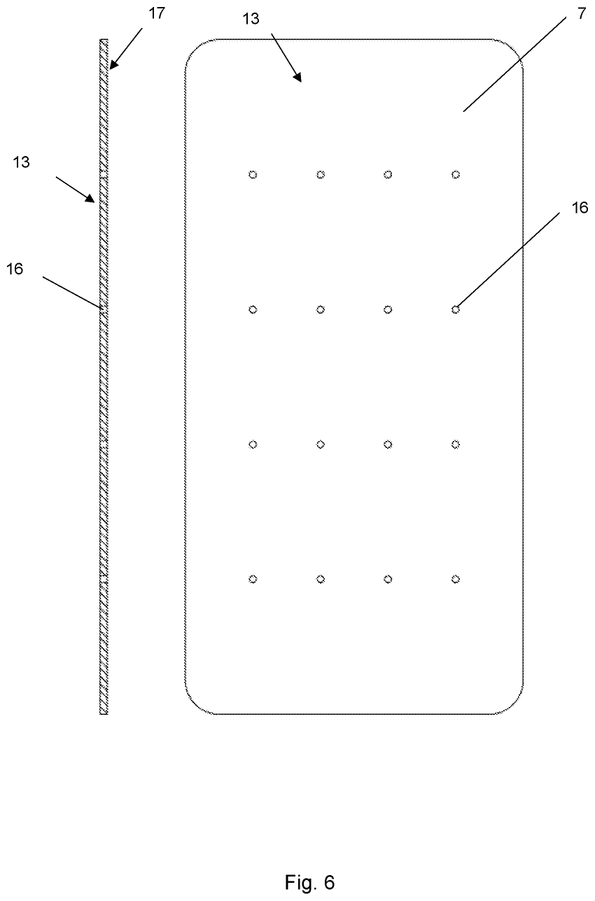

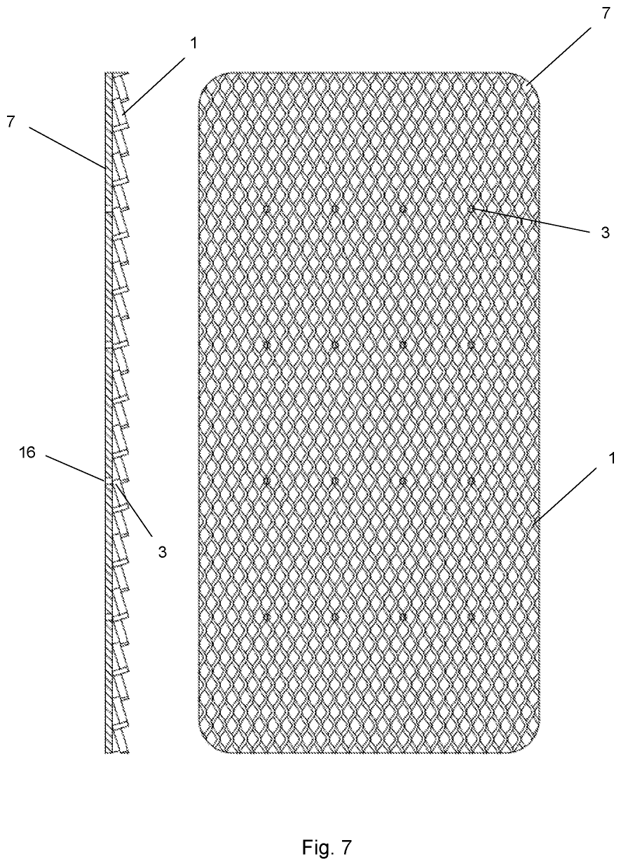

The expanded metal layer 1 represented in FIG. 1 is used in the first process control according to the disclosure according to FIGS. 2 to 5 as well as in the second process control according to FIGS. 6 and 7 as an additional expanded metal layer.

As intended, it forms in the final assembled state in this form or in the modified form the outer expanded metal layer on the bipolar plate side.

FIGS. 2 to 5 show a first process control according to the disclosure by referring to the expanded metal layer 1 represented in FIG. 1.

This being, first a stack 11 of expanded metal layers 4, 5, 6 arranged layerwise, a bipolar plate 7 and an additional expanded metal layer in the form of the expanded metal layer 1 are provided.

FIG. 2 now shows that a total of four identical planar sections 7 comprising several meshes 2 are completely removed from the expanded metal layer 1. Only one section 8 is shown in FIG. 2. In this case, the sections 8 are cut out of the expanded metal layer 1 by means of a laser cutting method. The sections 8 have here a circular contour. There result from the removal of the sections 8 four first expanded metal elements 8 in the form of the removed sections 8 and a second expanded metal element 9 in the form of the remaining expanded metal layer 1 with four circular through holes 10 corresponding to the removed sections 8.

The meshes 2 and the intersection points 3 are clearly to be recognized in the enlarged representation of the section 8.

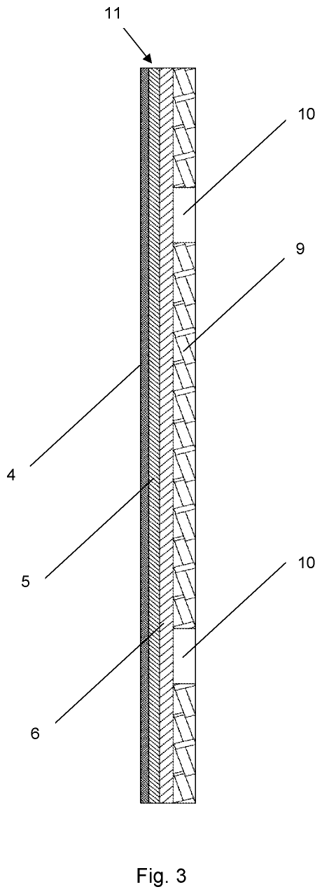

As represented in FIG. 3, the second expanded metal element 9 is then aerally welded onto the expanded metal layer 6 of the stack 10 facing it. A resistance projection welding method is used hereto. The second expanded metal element 9 is added to the stack 11 by welding and is, in the final assembled state, together with the first expanded metal elements in the form of the outer expanded metal layer 14, a part of the gas diffusion electrode that is formed by the whole stack 11 in the final assembly state.

The weld projections in the form of the intersection points of the second expanded metal element 9 are at least partially melted off by welding. The plastic height of the welded expanded metal element 9 is thus lower than the plastic height of the unwelded expanded metal element 9 and thus also than the plastic height of the unwelded first expanded metal elements 8.

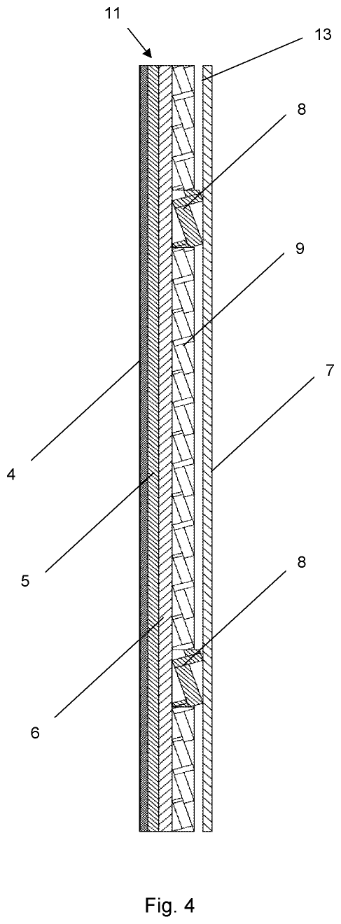

A subsequent snapshot of the first method is represented in FIG. 4. The first expanded metal elements 8 are inserted again accurately into the through holes 10. This being, they are in contact with the second expanded metal element 9 and the expanded metal layer 6 of the stack 11. Moreover, the bipolar plate 7 with its large surface 13 is brought into contact with the first expanded metal elements 8.

As can be seen, the unwelded first expanded metal elements 8 project over the second expanded metal element 9 in the thickness direction that corresponds in this case to the direction of the stack 11. The bipolar plate 7 is thus adjacent solely to the intersection points 3 of the first expanded metal elements 8. A contact between the second expanded metal element 9 and the bipolar plate 7 does not exist at that time. In this case, the bipolar plate is made of titanium.

In the subsequent step, the at this stage projecting first expanded metal elements 8 can be used as weld projections and thus make possible the use of the subsequent resistance projection welding for welding the bipolar plate 7 and the outer expanded metal layer 14. This being, the weld projection in the form of the projecting part of the first expanded metal elements 8 is almost completely melted off. There thus exists a material bond between the bipolar plate and the outer expanded metal layer in the region of the first expanded metal elements. During the welding step or in the later course, a contact with the bipolar plate 7 can be realized in the region of the second expanded metal element 9 by means of compression. Moreover, it is provided that the single expanded metal elements 8, 9 are welded during this welding step to a largely uniform outer expanded metal layer 14. As a result, the previously separated elements 8, 9 are thus reassembled to a multipart though materially bonded expanded metal layer 14.

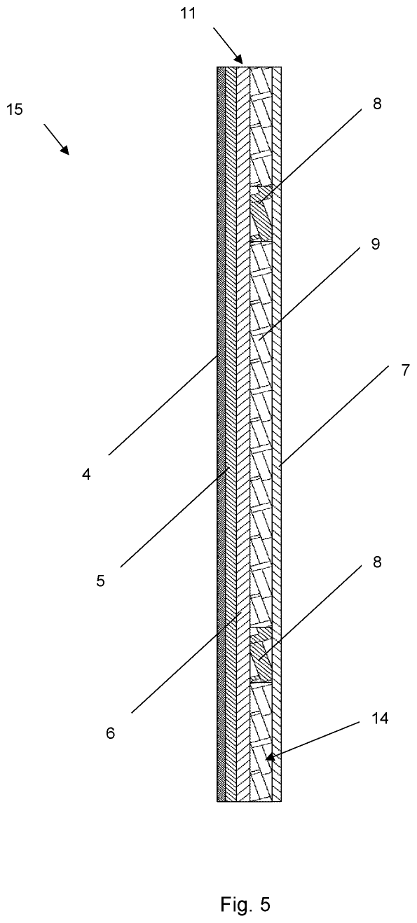

FIG. 5 shows a bipolar plate electrode assembly 15 according to the disclosure that is produced according to the first process control according to the disclosure.

The bipolar plate electrode assembly 15 can be recognized. It comprises the stack 11 that forms the electrode that is made of expanded metal layers 4, 5, 6, 14 arranged layerwise and the bipolar plate 7 areally welded to the outer expanded metal layer 14 on the bipolar plate side. It can be seen that the intersection points 3 of the first expanded metal elements 8 that are welded to the bipolar plate 7 are melted off. The materially bonded connecting areas between the expanded metal layer 14 and the bipolar plate 7 are thus advantageously enlarged.

The different hatching here represents that the expanded metal layers 4, 5, 6, 14 of the stack 11 have different mesh sizes. A specific mesh size is provided depending on the expanded metal layer. This mesh width varies from expanded metal layer to expanded metal layer. This configuration is advantageous in particular in two respects. This supports a turbulent fluid throughflow that is desirably to be achieved in the intended use case. Moreover, it results in an uneven distribution of the contact points developing between the single expanded metal layers 4, 5, 6, 14, which additionally enhances the form stability of the later stack.

This being, it is provided that the meshes 2 of the outer expanded metal layer 14 adjacent to the bipolar plate 7 of the bipolar plate electrode assembly 15 has the largest mesh size. This being, the expanded metal layers 4, 5, 6, 14 are preferably successively arranged in the stack so that the mesh size of the expanded metal layers 4, 5, 6, 14 reduces in the direction of the stack starting from the outer expanded metal layer 14 connected to the bipolar plate 7. This being, the aim of the larger mesh expanded metal is on the one hand to form a stable and plane surface but on the other hand also to build up a spring effect. It is consequently preferably provided that the outer expanded metal layer 14 that, in the intended use case, comes into contact with the bipolar plate 7 of the bipolar plate electrode assembly 15 has the largest mesh size of all expanded metal layers 4, 5, 6, 14. So it is ensured that the outer expanded metal layer 14 connected to the bipolar plate 7 has particularly enhanced spring-elastic properties. This is favorable for the method of manufacturing as well as for the later fuel cell or the electrolysis device.

Referring to the expanded metal layer 1 represented in FIG. 1, FIGS. 6 and 7 show a second process control according to the disclosure.

This being, first a stack 11 of expanded metal layers 4, 5, 6 arranged layerwise, a bipolar plate 7 and an additional expanded metal layer in the form of the expanded metal layer 1 are provided.

The expanded metal layer 1 comprises a multitude of intersection points 3 arranged regularly distributed over a flat side. Referring to the drawing plane in FIG. 1, the flat side is the flat side that lies above in the top view.

As represented in FIG. 6, the bipolar plate 7 is first provided with a multitude of through holes 16. The through holes 14 entirely penetrate through the bipolar plate 7 and extend between its two large surfaces 13, 17.

The through holes 16 holes are made by laser cutting in the bipolar plate 7 preferably made of titanium. The through holes correspond with respect to their geometrical size and orientation to the intersection points 3 of the meshes of the expanded metal layer 1 adjacent to the bipolar plate 7. In accordance with the total of 16 intersection points 3 marked in FIG. 1, 16 corresponding through holes 16 are formed in the bipolar plate 7 as well.

FIG. 7 shows that the bipolar plate 7 and the expanded metal layer 1 are brought into contact with one another. This being, each through hole 16 of the bipolar plate 7 is positioned over a corresponding intersection point 3 of the expanded metal layer 1.

The following method steps are not represented. This being, the bipolar plate 7 and the expanded metal layer 1 are then aerally welded together to a compound by means of TIG welding under inert gas atmosphere with argon. This being, at least one welding electrode is inserted into the through holes 16 and a welding connection is configured in the region of the intersection points 3 by adding an additive of titanium between the bipolar plate 7 and the expanded metal layer 1.

In the course of the TIG welding, the holes are filled with an additive of titanium. This being, there results a material bond between the expanded metal layer 1, formed in particular of titanium, on the one hand and the bipolar plate 7 formed of titanium on the other hand. It results that the bipolar plate 7 is permanently materially fixed to the expanded metal layer 1 so that setting phenomena are avoided. Additionally, a metal-to-metal connection is created between the expanded metal layer 1 and the bipolar plate 7 so that a minimized ohmic resistance develops. As a result, the ohmic resistance between the gas diffusion electrode and the bipolar plate 7 is permanently reduced.

For forming the bipolar plate electrode assembly according to the disclosure, the expanded metal layer 6 on the compound side of the stack 11 made of expanded metal layers 4, 5, 6 arranged layerwise and the expanded metal layer 1 of the compound are areally welded with one another by resistance welding.

1. A bipolar plate electrode assembly of a fuel cell or of an electrolysis device comprising a stack of expanded metal layers arranged layerwise that form a gas diffusion electrode and a bipolar plate, wherein the stack is limited in the direction of the stack at least at one end by an outer expanded metal layer, wherein the outer expanded metal layer is areally materially bonded to the bipolar plate, characterized in that the outer expanded metal layer is made of two parts and comprises an expanded metal element as well as a metal insert inserted into the expanded metal element and materially bonded to the expanded metal element, wherein the outer expanded metal layer is materially bonded to the bipolar plate solely in the region of the metal insert.

2. The bipolar plate electrode assembly according to claim 1, wherein at least the outer expanded metal layer is made of titanium.

3. The bipolar plate electrode assembly according to claim 1, wherein the at least the outer expanded metal layer has a grid structure, wherein the grid structure consists of intersecting webs that form single meshes on the one hand and intersection points on the other hand, wherein the planar outer side is formed by a multitude of intersection points arranged in a common plane, wherein materially bonded connection points are formed between each intersection point and one corresponding contact point of the bipolar plate.

4. The bipolar plate electrode assembly according to claim 1, wherein the at least one part of the expanded metal layers of the stack has different mesh sizes, wherein the expanded metal layers are preferably successively arranged in the stack so that the mesh size of the expanded metal layers reduces in direction of the stack starting from the outer expanded metal layer connected to the bipolar plate.

5. The bipolar plate electrode assembly according to claim 3, wherein the outer expanded metal layer connected to the bipolar plate has a regular mesh size, wherein the preferred mesh size is formed of a mesh width of 12 mm and a mesh length of 6 mm.

6. The bipolar plate electrode assembly according to claim 1, wherein the metal insert is made of expanded metal or of a wire mesh.

7. The bipolar plate electrode assembly according to claim 1, wherein the material bond between the outer expanded metal layer and the bipolar plate is configured as a welding connection, in particular as a resistance projection welding connection or a fusion welding connection.

8. A method for producing a bipolar plate electrode assembly of a fuel cell or of an electrolysis device according to claim 1 for which a gas diffusion electrode made of expanded metal layers, a bipolar plate and an additional expanded metal layer are provided;
a planar section comprising several meshes is completely removed from the additional expanded metal layer, wherein at least one first expanded metal element in the form of the removed section and a second expanded metal element in the form of the remaining expanded metal layer with a through hole corresponding to the removed section are formed out of the additional expanded metal layer;
the second expanded metal element is welded onto an outer expand metal layer of the gas diffusion electrode by resistance welding,
the first expanded metal element is then inserted again into the through hole of the second expanded metal element,
the bipolar plate is welded onto the planar side of the first expanded metal element facing away from the gas diffusion electrode by resistance projection welding, wherein the bipolar plate and the first expanded metal element are welded to one another preferably in one operation and wherein the first expanded metal element and the second expanded metal element are welded to one another.

9. The method according to claim 8, wherein forming the first expanded metal element the section is removed from the additional expanded metal layer by laser cutting.

10. The method according to claim 8, wherein the gas diffusion electrode is formed of expanded metal layers that are stacked layerwise, wherein the mesh size of the expanded metal layers increases as the stack height increases.

11. The method according to claim 10, wherein the second expanded metal element is welded onto the expanded metal layer of the gas diffusion electrode that has the largest mesh size inside the gas diffusion electrode, wherein the second expanded metal element has a larger mesh size than the expanded metal layer of the gas diffusion electrode onto which it is welded.

12. The method according to claim 9, wherein the first expanded metal element is inserted into the second expanded metal element in such a manner that its relative orientation to the second expanded metal element corresponds to its orientation before its removal.

13. The method according to claim 9, wherein compliance with the first section, further sections are completely removed from the additional expanded metal layer and/or of the second expanded metal element for forming further expanded metal elements before the welding of the second expanded metal element, are inserted again into the welded second expanded metal element and are then welded by resistance projection welding with the bipolar plate on the one hand and with the second expanded metal element on the other hand, preferably simultaneously with the first expanded metal element.
